(19) United States
(12) Patent Application Publication
(10) Pub. No.: US 2023/0032330 A1
(43) Pub. Date: Feb. 2, 2023

(54) PERSONAL CARE DEVICE

(71) Applicant: Braun GmbH, Kronberg (DE)

(72) Inventors: Christian Neyer, Eschborn (DE); Martin Fuellgrabe, Bad Camberg (DE)

(21) Appl. No.: 17/875,486

(22) Filed: Jul. 28, 2022

(30) Foreign Application Priority Data
Jul. 29, 2021 (EP) 21188506.6

(51) Int. Cl. B26B 19/38

(52) U.S. Cl. CPC B26B 19/388; B26B 19/3853; B26B 19/048

(57) ABSTRACT

The present invention relates to a personal care device, in particular hair removal device such as an electric shaver, comprising an elongated handle for manually moving the personal care device in short and/or long strokes along a body surface, a working head attached to said handle for effecting a personal care treatment to said body surface, and a determination unit including at least one sensor for determining stroke length to differentiate between short and long strokes, wherein said determination unit is configured to determine velocity of the working head and/or the handle, to determine beginning and end points of strokes when the determined velocity gets zero and/or changes signs, and to determine stroke length from the distance between pairs of beginning and end points next to each other.

### FIELD OF THE INVENTION

The present invention relates to a personal care device, in particular hair removal device such as an electric shaver, comprising an elongated handle for manually moving the personal care device in short and/or long strokes along a body surface, a working head attached to said handle for effecting a personal care treatment to said body surface, and a determination unit including at least one sensor for determining stroke length to differentiate between short and long strokes.

### BACKGROUND OF THE INVENTION

Personal care devices are widely used to apply different types of personal care treatments to users, wherein such personal care devices may include hair removal devices such as epilators, shavers or razors which may be electric or manual and/or wet or dry, or beard trimmers. Furthermore, other personal care devices include dental care appliances such as electric or manual tooth brushes, interdental cleaners or gum massaging devices, or skin treatment devices such as massaging devices or vibrators. All such personal care devices are subject to the problem that different users use the personal care devices in different ways and the same user may behave differently from one stroke or shave to the next stroke or shave and different users have different preferences for the mechanical settings of the personal care device.

In a more general context, some users tend to rather strongly press the working head against the body surface to be treated, whereas other users apply rather slight pressure. Some users tend to move the working head over the body surface in rather short strokes, whereas other users apply longer strokes. Depending on the user habits and preferences, the working head should provide for a softer or more controllable working head user feeling what can be addressed by different movability characteristics of the suspension allowing for movements of the working head relative to the handle and/or movements of the working head element relative to the working head basis. The preferences also change during a single shave, e.g. depending on the phase of the shave or due to other reasons that are completely up to the user.

Changing the movability characteristics of moveable hair or body treatment parts of the device relative to non-moveable parts (as e.g. the handle) also may be desirable for the same user when using the personal care device in different treatment modes or at different body portions. For example, when shaving the upper lip region below the nose, short strokes are often made and more control is desired so working head stiffness should be increased, whereas shaving the cheeks or the region around the adam's apple in long strokes may require less stiffness and/or a wider pivoting/swiveling range to achieve better contour adaption.

More generally, there are two main cases where the detection of short strokes is particularly relevant to detect a behavior change and be able to adjust at least one operation parameter of the personal care device. Firstly, in situations or regions where users are not able to achieve the desired goal of a precise, thorough personal care treatment such as a clean shave without remaining hairs, a very common human behavior is to reduce the specific stroke length from a standard value to a significantly shorter movement, i.e. the handle and thus, the working head is moved back and forth or up and down in strokes of reduced length. Secondly, in areas like the upper lip, anatomical boundaries only allow short strokes as consumers typically do not want to touch such anatomical boundaries such as their lips or the nose with the personal care device. In such situations, the users often prefer a stiffer configuration of the moveable treatment parts of the personal care device giving more control or less on a treatment characteristic of the device.

To have the device's configuration match the stroke pattern and thus, the user's behavior, various adaptions may be effected to the personal care device. For example, the suspension of the working head relative to the handle and/or the suspension of the working head element relative to a working head basis may allow for various types of movements of the working head and the working head element, respectively, such as rotatory movements and/or linear movements thereof. More particularly, the working head may tilt and/or swivel relative to the elongated handle, wherein a tilt axis and a swivel axis may extend substantially parallel to the skin contact surface of the working head and transverse to each other. In addition or in the alternative, the working head may dive or float relative to the handle along a diving axis substantially perpendicular to the skin contact surface and/or substantially parallel to the longitudinal axis of the handle. Similarly, a working head element such as a shear foil cartridge of a shaver may tilt and/or swivel and/or dive relative to the working head frame or working head basis to allow adaption to the skin contour.

So as to meet different users' habits and preferences, the suspension of the working head and/or the suspension of the working head element relative to the working head basis may be adjusted to change the characteristics of the adapting movements of the working head and/or the working head element to the skin contour. For example, the tilting and/or swiveling and/or diving stiffness may be increased or decreased to provide for a preciser or a softer characteristic of the adaption movements. Furthermore, also the tilting and/or swiveling and/or diving range in terms of the maximum rotatory and/or linear displacement may be varied.

For example, EP 3 546 153 B1 shows an electric shaver changing its configuration in response to stroke length. More particularly, stroke length is detected by means of an accelerometer or an optical system including a camera, wherein in response to detected stroke length pivoting stiffness of the working head is adjusted. More particularly, the shaver has a pivotable suspension of its working head to allow for pivoting of the working head relative to the handle and a diving suspension of the shear foil cartridge to allow for diving of the shear foil cartridge relative to the working head frame. The pivoting stiffness of the working head and the diving stiffness of the shear foil cartridge are controlled by means of mechanical springs which can be adjusted by means of actuators so as to increase and decrease pivoting stiffness and diving stiffness in terms of the torque and force necessary to achieve a certain pivot angle and a certain diving displacement. Moreover, the adjustment mechanism is configured to adjust the angular pivoting range of the working head to allow a larger or smaller maximum angular displacement.

A similar adjustability of the working head of an electric shaver is shown by document EP 35 46 152 B1, wherein it is suggested to detect stroke properties such as speed and length by an accelerometer and stroke property such as direction and pattern related to rotational movements of the shaver by means of a gyroscope.

Another option of adjusting the treatment characteristic is adjustment of the cutting length of a hair trimmer, wherein for example document WO 2018/069265A1 discloses a hair trimmer including an adjustment actuator for adjusting the cutting length of the trimmer

WO 2009/006011 A1 discloses a grooming tool is that includes an acceleration sensor that initiates the operation of the device.

### SUMMARY OF THE INVENTION

It is an objective underlying the present invention to provide for an improved personal care device avoiding at least one of the disadvantages of the prior art and/or further developing the existing solutions.

A more particular objective underlying the invention is to achieve a precise, reliable differentiation between long strokes and short strokes without complicated sensor equipment.

Another objective underlying the invention is to achieve robust determination of stroke length despite different specific behaviors of different users such as gripping the handle in different ways and different preferred directions of moving the working head along the body surface.

To achieve at least one of the aforementioned objectives, it is suggested to determine stroke length on the basis of velocity or a physical property related to that of the working head and/or of the handle of the personal care device to allow for use of reduced sensor equipment, and to analyze velocity to determine stroke length. More particularly, the determination unit provided for determining stroke length to differentiate between short and long strokes, may be configured to determine beginning and end points of strokes when velocity of the working head and/or of the handle gets zero or close to zero and/or changes its sign from positive to negative and/or vice versa from negative to positive or on basis of another detected change of a property value, and to determine the stroke length from the distance and/or path length between pairs of beginning and end points next to each other.

Analysis of the velocity of the working head and/or the handle allows for determination of the stroke length and, more particularly, differentiation between long strokes and short strokes, without necessitating complex sensor equipment such as cameras or image sensors, and allows control of adaptions of relevant configuration parameters such as working head stiffness not only for use in difficult regions such as the upper lip region, but also when the user encounters other problems such as difficult hair and therefore changes behavior in terms of changing from long strokes to short strokes or vice versa.

It is to be understood that the term “stroke” may encompass linear or straight paths but also curved movement paths or combinations of both of the shaver. As the sensor contributing in the detection of stroke length may at least detect changes along one axis (or more) the derived sensor signal is also able to detect changes independent from as to whether the movement path is curved or linear or in other words it may detect in case of a curved path the changes (e.g. of direction change or changes of the sign from positive to negative) along the at least one main axis of measurement. Furthermore, it is understood that the shaver is not in any way limited in the way it can be moved on the skin to be treated or the body-portion to be shaved. The determination unit is able to differentiate between short and long strokes on basis of any shaver movement on the skin as explained further below.

The velocity of the personal care device can be determined, for example, by means of a velocity sensor. However, advantageously, the velocity may be derived from an acceleration signal of an acceleration sensor measuring acceleration of the working head and/or of the handle. Such acceleration sensor may be positioned at the working head or at least close thereto to determine acceleration of the working head. For example, the acceleration sensor may be positioned close to the skin contact surface of the working head to determine acceleration at a position close to the interface of the working head to the skin or body surface to be treated. Consequently, the velocity which may be calculated or in another way derived from the acceleration signal, is close to the velocity of which the working head is moved over the body surface. In the alternative however, the acceleration sensor also may be accommodated in the handle for practical reasons, wherein in such case a correction of the acceleration signal may be carried out so as to provide for the acceleration of the working head and the skin contact surface thereof. Such correction, for example, can be achieved by means of determining the rotation of the handle and taking into account the known distance of the acceleration sensor at the handle from the skin contact surface.

So as to increase accuracy of the calculation of the velocity out of acceleration, disturbances distorting the acceleration signal and/or representing influences not corresponding to relevant movements of the personal care device can be eliminated. More particularly, a filter may be used for removing vibrations and/or an influence resulting from the vibrations of the shaver onto the acceleration signal. For example, a low pass filter may be used such as a low pass filter of second order. Irrespective of the specific type of filter, the filter may have a cutoff frequency set between the frequency of relevant vibrations and the highest possible frequency of manual movements or movements of the hand of a user. For example, a cutoff frequency in the range of 25-35 Hz or substantially 30 Hz may be used.

In addition or in the alternative to filtering influences resulting from vibrations, the influence of gravity onto the acceleration signal may be removed. More particularly, a filter such as a high pass filter may be used to remove the fraction of the measured signal which is due to gravity. Such filtering is based on the assumption that the influence of gravity is rather slowly changing, whereas the stroke movements of the handle are considerably faster. It is to be understood that low pass filter characteristic and high pass filter characteristic may be combined with a so called band pass filter and referral to one of the low or high pass filters may also include referral to a band pass filter.

For example, the filter may have a cutoff frequency ranging from 1 Hz to 2 Hz, wherein a cutoff frequency of about 1.3 Hz may work well. Shorter time values might suppress real movements and larger time values might mix orientation changes of the personal care device which are not due to shaver strokes into the calculation.

Determining velocity from the acceleration signal may include integration over time. More particularly, the filtered acceleration signal may be integrated over time to obtain the velocity of the working head and/or of the handle of the personal care device.

Advantageously, a low pass filter may be used to obtain velocity. The property of a low pass filter may perform a mathematical integration for frequencies above the cutoff frequency. In other words, it is not the pass band of the filter which is used, but the properties of a region that is called stop band may be used for integration and obtaining the velocity from the acceleration signal.

For example, the cutoff frequency may be set at a value well below the frequency of stroke movements so as to make sure to integrate the stroke accelerations without significant losses. For example, a cutoff frequency ranging from 0.2-0.35 Hz or ranging from 0.25-0.30 Hz may be used. For example, a cutoff frequency of about 0.27 Hz may work well.

The acceleration sensor may measure acceleration in at least one direction of interest, for example up and down acceleration or acceleration in a direction which is substantially parallel to the skin contact surface of the working head and substantially perpendicular to a front side of the handle where a thumb is usually placed and/or an on/off-switch is often placed. When the working head has a substantially rectangular cross-section, and/or elongated working elements such as an elongated shear foil cartridge, said direction in which acceleration is measured, may be substantially parallel to the skin contact surface and substantially perpendicular to the longer axis of the rectangular cross-section and/or perpendicular to the longitudinal axis of the elongated working element. Advantageously, the acceleration sensor is configured to measure accelerations along at least one of a first axis extending in the longitudinal handle direction, a second axis extending perpendicular to the first axis and through a front and back side of the handle and/or a third axis perpendicular to the first and second axis.

Nevertheless, the acceleration sensor may be a multi-axial sensor for measuring accelerations in at least two or three axes, for example, the accelerations along a pair of axes perpendicular to each other and parallel to the skin contact surface of the working head.

Advantageously, the at least one measuring axis of the acceleration sensor is an axis having a fixed orientation relative to the personal care device. In other words, acceleration is not measured along axes fixed in space. The acceleration is measured along axes fixed to the working head and/or to the handle of the personal care device.

When the personal care device is rotated, the acceleration signal will be effected by such rotation so the velocity values determined from the acceleration signal will change and will be affected by such rotation. So as to eliminate, or at least reduce, such influence of rotations of the device, a rotation sensor may be provided or, more generally, rotation of the working head and/or of the handle of the personal care device may be measured or determined.

Advantageously, inaccuracies of the velocity calculated from the acceleration signal may be corrected by using rotatory speed which may be measured by a rotation sensor, and by the distance between the acceleration sensor and the skin contact surface of the working head. Depending on the direction of rotation, the rotatory fraction may be added to or subtracted from the velocity calculated from the acceleration signal of the acceleration sensor.

So as to correctly recognize a transition from a long stroke pattern to a short stroke pattern or vice versa from a short stroke pattern to a long stroke pattern, the determined stroke length may be compared to a reference value or threshold, wherein said reference value or threshold may be determined from an average value of the length of a sufficient number of previous strokes. More particularly, the determination unit may be configured to determine a sliding average of the length of a predetermined number of previous strokes, wherein at least the last two strokes are taken into account for determination of the sliding average. For example, the last three or last five or last ten strokes may be taken into account and/or a sliding average as specified over a predetermined time period which is considered to determine the sliding average of stroke length.

Basically, said sliding average could be taken as threshold to which a currently determined stroke length can be compared to determine whether it is a short stroke or a long stroke. However, the determination unit may be configured to apply a scaling factor or a plurality of scaling factors to the stroke length of the preceding strokes taken into account for the calculation of the sliding average. More particularly, such sliding factor can be chosen to give more weight to the latest stroke or a couple of latest strokes. Such scaling factor helps to achieve a sufficient quick reaction and at the same time, provides for a continuous adaption of the system. According to one aspect, the determination unit is provided for determining the stroke length during the body treatment operation, in particular in real time. Thus the benefits of this discrimination in stroke length can be used within the same or a single shaving procedure.

The personal care device comprises two separate parts, the first part is provided for effecting the body treatment and the second part comprising at least partially the determination unit. Thus the determination unit can be part of the personal care device but can also be separate from that.

The second part being effected in a smart device as e.g. a smartphone or a wearable device. By this at least the microprocessor power of the smartphone can be used for making all calculations and provide the least additional visualizations of the shaving procedure within a Software App designated for that.

Personal care device, in particular hair removal device such as an electric shaver, comprising an elongated handle (40) for manually moving the personal care device (2) in short and/or long strokes (30, 31) along a body surface (5), a working head (41) attached to said handle (40) for effecting a personal care treatment to said body surface (5), and a determination unit (42) including at least one sensor for determining stroke length to differentiate between short and long strokes, wherein a second sensor configured to measure correction signals for correcting the stroke length determination signal is provided Such second sensor could be e.g. a rotation sensor as mentioned above in order to eliminate handle rotations which have no effect on shaving strokes.

In addition or in the alternative, the determination unit may be configured to disregard stroke lengths exceeding a predefined maximum. Disregarding strokes which are too long and thus sort of unreasonable, helps the system in reasonable differentiating between usual long and short strokes commonly used by the specific user.

### BRIEF DESCRIPTION OF THE DRAWINGS

FIG. 1: a side view of a personal care device including an elongated handle pivotably supporting a working head with a skin contact surface contacting the body surface of a user, wherein the personal care device may be an electric shaver and includes a determination unit including an acceleration sensor accommodated in the handle to determine stroke length and differentiate between long and short strokes,

FIG. 2: a flow chart showing the measuring and evaluation steps performed by the determination unit of the personal care device to determine long strokes and short strokes,

FIG. 3: a functional diagram showing velocity of the personal care device verses stroke length, wherein a region of short strokes to be detected is indicated in said functional diagram, and

FIG. 4: a perspective front view of a users' face showing the regions where typically short strokes and long strokes are applied.

### DETAILED DESCRIPTION OF THE INVENTION

As can be seen from the figures, it is suggested to determine stroke length based on velocity of the working head and/or of the handle of the personal care device to allow for use of reduced sensor equipment, and to analyze velocity to determine stroke length. More particularly, the determination unit provided for determining stroke length to differentiate between short and long strokes, may be configured to determine beginning and end points of strokes when velocity of the working head and/or of the handle gets zero and/or changes its sign from positive to negative and vice versa from negative to positive, and to determine the stroke length from the distance and/or path between pairs of consecutive beginning and end points next to each other. Analysis of the velocity allows for differentiation between long strokes and short strokes, without necessitating complex sensor equipment such as cameras or image sensors, and allows control of adaptions not only for use in difficult regions such as the upper lip region, but also when the user encounters other problems such as difficult hair and therefore changes behavior in terms of changing from long strokes to short strokes or vice versa.

The velocity of the personal care device can be determined, for example, by means of a velocity sensor. However, advantageously, the velocity may be derived from an acceleration signal of an acceleration sensor measuring acceleration of the working head and/or of the handle. Such acceleration sensor may be positioned at the working head or at least close thereto to determine acceleration of the working head. For example, the acceleration sensor may be positioned close to the skin contact surface of the working head to determine acceleration at a position close to the interface of the working head to the skin or body surface to be treated.

Consequently, the velocity which may be calculated or in another way derived from the acceleration signal, is close to the velocity of which the working head is moved over the body surface. In the alternative however, the acceleration sensor also may be accommodated in the handle for practical reasons, wherein in such case a correction of the acceleration signal may be carried out so as to provide for the acceleration of the working head and the skin contact surface thereof. Such correction, for example, can be achieved by means of determining the rotation of the handle and taking into account the known distance of the acceleration sensor at the handle from the skin contact surface.

So as to increase accuracy of the calculation of the velocity out of acceleration, disturbances distorting the acceleration signal and/or representing influences not corresponding to relevant movements of the personal care device can be eliminated. More particularly, a filter may be used for removing vibrations and/or an influence resulting from the vibrations of the shaver onto the acceleration signal. For example, a low pass filter may be used such as a low pass filter of second order. Irrespective of the specific type of filter, the filter may have a cutoff frequency set between the frequency of relevant vibrations and the highest possible frequency of manual movements or movements of the hand of a user. For example, a cutoff frequency in the range of 25-35 Hz or substantially 30 Hz may be used.

In addition or in the alternative to filtering influences resulting from vibrations, the influence of gravity onto the acceleration signal may be removed. More particularly, a filter such as a high pass filter may be used to remove the fraction of the measured signal which is due to gravity. Such filtering is based on the assumption that the influence of gravity is rather slowly changing, whereas the stroke movements of the handle are considerably faster.

For example, the filter may have a cutoff frequency ranging from 1 Hz to 2 Hz, wherein a cutoff frequency of about 1.3 Hz may work well. Shorter time values might suppress real movements and larger time values might mix orientation changes of the personal care device not due to strokes into the calculation.

Determining velocity from the acceleration signal may include integration over time. More particularly, the filter acceleration signal may be integrated over time to obtain the velocity of the working head and/or of the handle of the personal care device.

Advantageously, a low pass filter may be used to obtain velocity. The property of a low pass filter may perform a mathematical integration for frequencies above the cutoff frequency. In other words, it is not the pass band of the filter which is used, but the properties of a region that is called stop band may be used for integration and obtaining the velocity from the acceleration signal.

For example, the cutoff frequency may be set at a value well below the frequency of stroke movements so as to make sure to integrate the stroke accelerations without significant losses. For example, a cutoff frequency ranging from 0.2-0.35 Hz or ranging from 0.25-0.30 Hz may be used. For example, a cutoff frequency of about 0.27 Hz may work well.

The acceleration sensor may measure acceleration in at least one direction of interest, for example up and down acceleration or acceleration in a direction which is substantially parallel to the skin contact surface of the working head and substantially perpendicular to a front side of the handle where a thumb is usually placed and/or an on/off-switch is often placed. When the working head has a substantially rectangular cross-section, and/or elongated working elements such as an elongated shear foil cartridge, said direction in which acceleration is measured, may be parallel to the skin contact surface and perpendicular to the longer axis of the rectangular cross-section and/or perpendicular to the longitudinal axis of the elongated working element.

Nevertheless, the acceleration sensor may be a multi-axial sensor for measuring accelerations in at least two or three axes, for example, the accelerations along a pair of axes perpendicular to each other and parallel to the skin contact surface of the working head.

Advantageously, the at least one measuring axis of the acceleration sensor is an axis having a fixed orientation relative to the personal care device. In other words, acceleration is not measured along axes fixed in space, but along axes fixed to the working head and/or to the handle of the personal care device.

When the personal care device is rotated, the acceleration signal will be effected by such rotation so the velocity values determined from the acceleration signal will change and will be affected by such rotation. So as to eliminate, or at least reduce, such influence of rotations of the device, a rotation sensor may be provided or, more generally, rotation of the working head and/or of the handle of the personal care device may be measured or determined.

Advantageously, inaccuracies of the velocity calculated from the acceleration signal may be corrected by using rotatory speed which may be measured by a rotation sensor, and by the distance between the acceleration sensor and the skin contact surface of the working head. Depending on the direction of rotation, the rotatory fraction may be added to or subtracted from the velocity calculated from the acceleration signal of the acceleration sensor.

So as to correctly recognize a transition from a long stroke pattern to a short stroke pattern or vice versa from a short stroke pattern to a long stroke pattern, the determined stroke length may be compared to a reference value or threshold, wherein said reference value or threshold may be determined from an average value of the length of a sufficient number of previous strokes. More particularly, the determination unit may be configured to determine a sliding average of the length of a predetermined number of previous strokes, wherein at least the last two strokes are taken into account for determination of the sliding average. For example, the last three or last five or last ten strokes may be taken into account or a predetermined time period to be observed to determine the sliding average of stroke length.

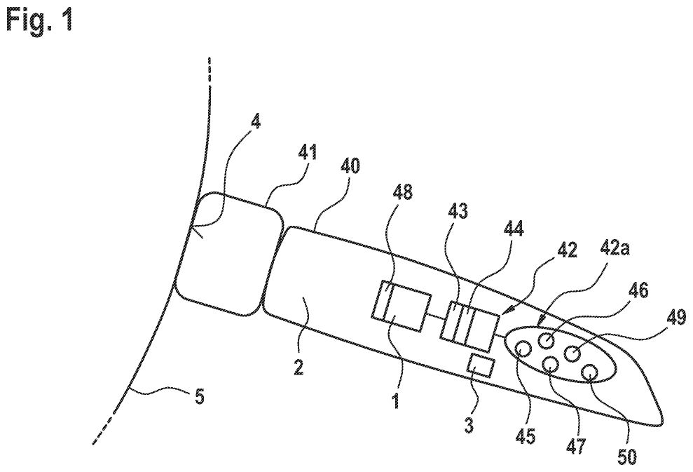

Basically, said sliding average could be taken as threshold to which a currently determined stroke lengths can be compared to determine whether it is a short stroke or a long stroke. However, the determination unit may include a scaling factor applicator 47, cf. FIG. 1, to apply a scaling factor or a plurality of scaling factors to the stroke length of the preceding strokes taken into account for the calculation of the sliding average. More particularly, such sliding factor can be chosen to give more weight to the latest stroke or a couple of latest strokes. Such scaling factor helps to achieve a sufficient quick reaction and at the same time, provides for a continuous adaption of the system.

So as to avoid disturbing the differentiation between long strokes and short strokes, a counter for the number of short strokes may be incremented whenever a short stroke was detected in the previous step. Such counter may be reset to zero whenever a stroke exceeds the maximum accepted length. Such a reset may even be done before a stroke ends. As soon as the current stroke becomes too long, the reset may be carried out.

Such resetting may achieve a fast reaction onto the user's behavior and may avoid negative affects onto the differentiation which could occur when slow long strokes follow fast short strokes.

Furthermore, the determined velocity may be checked as to whether it is reasonable. More particularly, the average of the absolute value of velocity of a short time interval in the past may be calculated and the aforementioned stroke counter may be reset if the aforementioned average value is lower than a predefined threshold. Such step may help in recognizing for example stops or interruptions of the treatment. For example, a stop or interruption of a shaver movement could otherwise be recognized as a very short stroke what can be prevented by means of the aforementioned check of the velocity.

So as to more reliably identify a true change in stroke pattern, the number of short strokes identified by the aforementioned counter can be compared with a minimum required number of short strokes, or vice versa a number of long strokes which may be counted by a long stroke counter can be compared with a minimum required number of long strokes. As soon as the minimum required number is reached or exceeded, a positive output signal may be created to indicate that a change in the stroke pattern has occurred. For example, said threshold or minimum required number may be two or three or five. A value of only one would pose the risk of erroneous output signals, whereas numbers larger than five or larger than three or even larger than two may increase the reaction time of the system. Thus, the determination unit may be considered as very sensitive if being able to react after one or two or less than six strokes already.

According to a further advantageous aspect, the control unit may constantly track the average stroke length and velocity during calculation and may adapt the thresholds according to these values to increase the accuracy of the behavior detection for the individual user so as to achieve a sort of self-learning and personalization of the device. For example, a shift of the threshold for the stroke length as used for disregarding strokes which are too long, and/or a shift of the threshold for the velocity as used for the identification of interruptions, may be carried out in this way.

As becomes apparent from the figures, a specific way of determining short strokes and long strokes and reliably differentiate between a short stroke pattern and a long stroke pattern is suggested to allow for a quick adaption of the configuration of the personal care device. The length of stroke movements during a treatment session such as a shave is determined and a signal is given as soon as the strokes are short, i.e. as soon as the geometric length of the strokes is lower than some predetermined value. This signal can be used for different purposes in the device, such as adjusting something. This invention is about determining the length of the strokes. The use of the resulting signal is subject to other inventions.

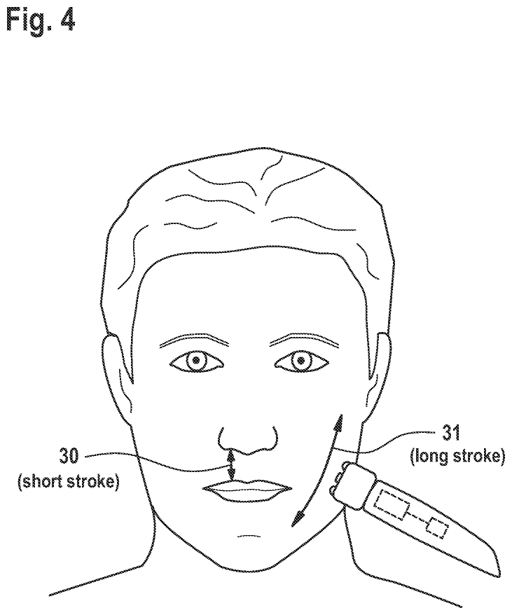

Strokes may be understood as the typically repeated movements of a personal care device 2 such as shaver on the skin of a user during a shave. FIG. 4 shows such movements. The measurement of their length may be done on the basis of data from an acceleration sensor and optionally also data from a gyro sensor measuring rotation. In addition to the measurements, also calculations are performed. As shown by FIG. 4, long strokes 31 typically may be carried out when shaving the cheek region, whereas on the other hand short strokes 30 are typically carried out in “difficult” regions having boundaries such as the region between the nose and the upper lip, cf. FIG. 4. As mentioned before, other reasons may make a user carry out short strokes.

As shown by FIG. 1, the personal care device 2 may be an electric shaver having an elongated handle 40 pivotably supporting a working head 41 which may swivel about a swivel axis and/or tilt about a tilt axis relative to the handle 40, wherein said tilt axis and/or pivot axis may extend substantially parallel to the skin contact surface 4 and, if both tilt and swivel axis are present, perpendicular to each other.

The working head 41 may carry one or more working tools such as cutting tools, for example, in terms of shear foil cartridges and/or a long hair trimmer having finger-like cutting blades.

In addition or in the alternative to such rotatory adjustability, the working head 41 also may be linearly displaceable relative to the handle 40, for example along an axis substantially perpendicular to the skin contact surface 4 to allow diving of the working head 41 relative to the handle 40. In addition or in the alternative, the working tools may be displaceable relative to a working head basis to allow for, for example, diving of the shear foil cartridges relative to the working head basis.

The movability of the working head 41 relative to the handle 2 and/or of the working tools relative to the working head basis may be adjusted by means of an adjustment actuator in response to the stoke length, as will be described in detail. More particularly, stiffness of the swiveling and/or tilting and/or diving may be adjusted from hard to soft depending on the user carrying out short strokes or long strokes.

A determination unit 42 is provided for determining the stroke length and for differentiating between short strokes and long strokes, wherein such determination unit 42 may include at least one sensor 1 such as an acceleration sensor and an electronic evaluation unit 42a which may be part of and/or connected to an electronic control unit for controlling the personal care device 2.

Such electronic control unit may include a microprocessor and a storage for storing program applications and/or data, wherein such electronic control unit also may control operation of the personal care device 2, including controlling the aforementioned adjustment actuator for making the suspension of the working head 41 stiffer or softer.

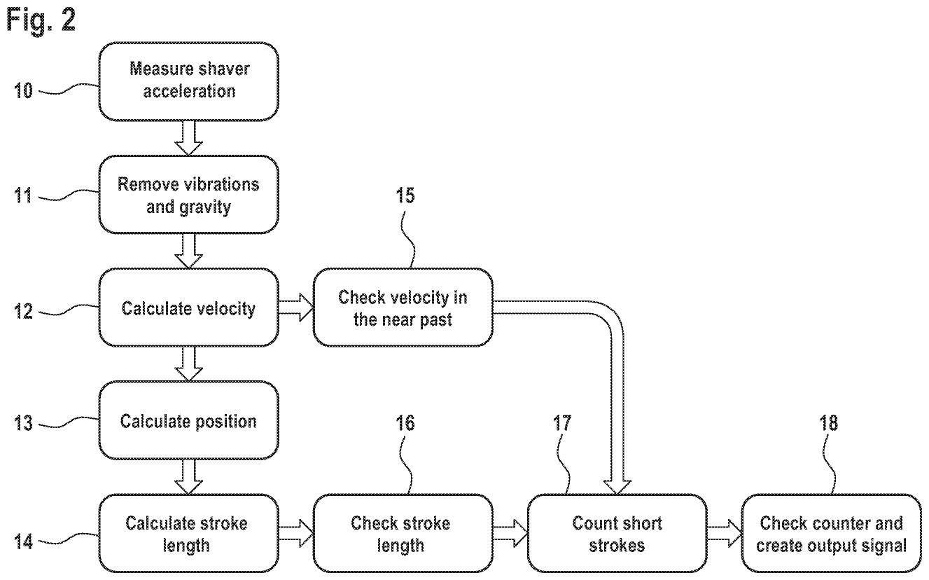

As can be seen from FIG. 2, the determination unit 42 may carry out the following steps, wherein all of the following steps or only some of them may be carried out and wherein the order of the steps may be changed irrespective of their numbering (wherein the numbering starting with 10 is due to other reference numerals used in other figures):

Step 10—Measurement of the Device Acceleration:

The acceleration of the device in at least one direction of interest, e.g. up-down may be measured, cf FIG. 2. This may be done via an acceleration sensor 1 in the device 2, shown in FIG. 1. It may also measure the gravity which is not desired, but unavoidable. A sensor 1 with analog output may be chosen.

Step 11—Removal of Vibrations:

A filter 43 may be used to remove influence resulting from vibrations of the personal care device 2. This filter 43, cf. FIG. 1, may be a low pass filter of 2nd order. Its cut-off frequency may be set between the frequency of the vibrations and the highest possible frequency of hand movements. For example, about 30 Hz is a good value.

The filter 43 may be built up in hardware. Alternatively, a combination of hard- and software filtering or only software filtering may be optionally possible.

The analog signal of the acceleration sensor may be digitized and the next steps may be performed on the basis of digital data.

Step 11—Removal of Gravity:

A high pass filter 44 may be used to remove the fraction of the measured signal which is due to gravity. This step may work with the assumption, that the influence of gravity is slowly changing and the stroke movements are faster.

A good value for the cut-off-frequency of this filter 44 is, for example, about 1.3 Hz. Shorter time values would suppress real movements and larger time values would mix orientation changes of the personal care device 2 that are not due to strokes into the calculation.

Step 12—Calculate Velocity:

The remaining portion of the acceleration signal may be integrated over time to obtain the velocity of the personal care device. This may be done with the help of a low pass filter 3. The property of a low pass filter to perform a mathematical integration for frequencies above the cut off frequency may be used. Usually, one could expect that the pass band of a filter is used. However, the properties of the region that is called stop band is used here.

The cut off frequency may be set at a value well below the frequency of stroke movements. In this way, one can make sure to integrate the stroke accelerations without significant losses. A good value of the cut off frequency is, for example about 0.27 Hz.

Measurement of rotation may be used to refine the determination of velocity from measured acceleration to increase the accuracy of the measurement and calculation. For the rotation measurement the correct axis should be chosen. When the up-down movement of the skin contact surface 4 of the personal care device is to be determined, the corresponding rotation axis is a left-right axis of the personal care device. In other words, the rotation axis monitored by the rotation sensor, is the axis about which rotations cause movements going into and/or opposite to the direction of the measured acceleration.

So as to refine calculation of the velocity value, movements due to rotation might be added/subtracted to/from the movements determined from the acceleration sensor 1. For example, the velocity of interest may be the velocity of the skin contact surface 4 of the working head 41, e.g. at the interface of the shaving foils and the skin 5, cf. FIG. 1. For practical reasons, the acceleration sensor 1 may be placed at a different position in the device, for example in the handle, cf. FIG. 1. As soon as the device is rotated, the velocity values determined from acceleration at the acceleration sensor 1 and true velocity at the skin contact surface 4 can be different.

This inaccuracy can be corrected by a correction unit 49 using the value for the rotation speed, measured by the rotation sensor 48 and by the known distance between the acceleration sensor 1 and the area of the device of interest, for example the skin contact surface 4.

Step 13—Calculate Position:

The position of the device 2 and more particularly, of the working head 41, may be calculated out of the velocity in the same way as the velocity may be calculated out of the acceleration. Such position calculation can be absolute or relative to other position values. A filter 3 with identical properties as mentioned before, may be used.

Step 14—Detect Beginning and End of Strokes:

Whenever the velocity of the personal care device changes sign, the current position of the personal care device may be considered as the end of a stroke and the beginning of the next one. The sign of the velocity may be taken from the previously calculated value of the velocity.

Step 14—Calculation of Stroke Length:

The current stroke length may continuously be calculated out of the position at the beginning of the stroke and the current device position. The value for the (preferably relative) position of the beginning of the stroke may be taken from the previous step and the current device position out of the previously described position calculation.

Step 16—Detection of a Short Stroke:

Whenever the end of a stroke is detected, a comparison of its length and a defined maximum acceptable length for short strokes 30 can be made by a comparator 45. If the stroke is shorter than this maximum length, it is accepted as a short stroke 30.

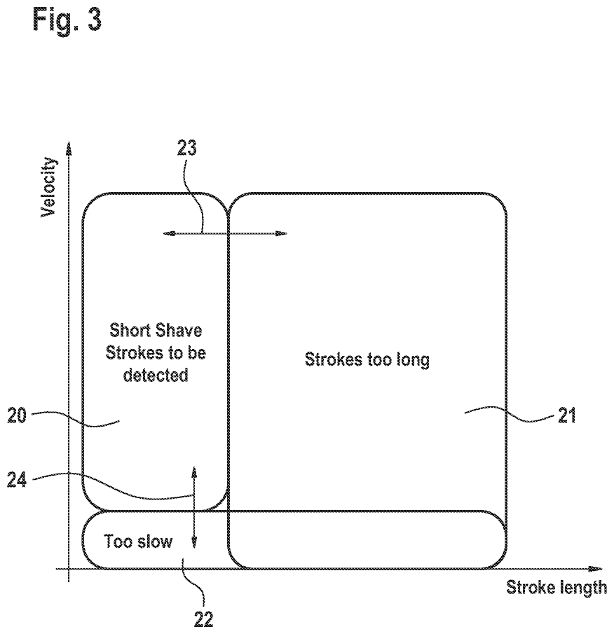

FIG. 3 shows a 2D-plot with the horizontal axis representing the stroke length. The region 21 in FIG. 3 represents strokes that are too long and therefore excluded in this step of the algorithm. Stroke 31 in FIG. 4 is an example for such a stroke, being too long. Stroke 30 in FIG. 4 is an example for a short stroke, being accepted in this step.

Step 17—Count the Short Strokes:

Whenever a short stroke 30 was detected in the previous step, a counter 50 for the number of short strokes may be incremented. This counter may be reset to 0 whenever a stroke exceeds the maximum accepted length. Such a reset may even be done before a stroke ends. As soon as the current stroke becomes too long, the reset is done. This approach helps in delivering a fast reaction on the users behavior. Slow long strokes after short strokes would otherwise fool the algorithm in a very disturbing way.

Step 15—Check the Velocity:

The average of the absolute value of the velocity of a short time interval in the past may be calculated and the stroke counter 50 may be reset if this value is lower than some defined threshold. This is important for recognizing e.g. stops in or interruptions of a treatment session such as a shave. A stop of the personal care device movement would otherwise be recognized as a very short stroke.

Region 22 in FIG. 2 represents the area that may be excluded from the short strokes because of such insufficient velocity.

Region 20 represents the shave strokes that are considered as valid short strokes.

Step 18—Check the Counter of Short Strokes:

The number of short strokes 30, counted in step 17 may be compared with a minimum required number of short strokes 30. As soon as this minimum required number is reached or exceeded, a positive output signal can be created. A minimum required number that turned out to be useful may be 2.

A value of only 1 may come with the risk of false output signals and larger numbers than 2 or than 3 or 5 may increase the reaction time of the algorithm to a disturbing level.

### Self-Learning/Personalization of the Device:

The control unit may constantly track the average stroke length and velocity during calculation and may adapt the thresholds according to these values to increase the accuracy of the behavior detection for the individual user.

A shift of the threshold for the stroke length, used in block 16 is indicated with the arrow 23 in FIG. 3.

A shift of the threshold for the velocity, used in block 15 is indicated with the arrow 24 in FIG. 3.

In addition or in the alternative, the determination unit may be configured to disregard stroke length exceeding a predefined maximum. Disregarding strokes which are too long and thus sort of unreasonable, helps the system in reasonable differentiating between usual long and short strokes commonly used by the specific user.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm ”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. Personal care device, in particular hair removal device such as an electric shaver, comprising an elongated handle for manually moving the personal care device in short and/or long strokes along a body surface, a working head attached to said handle for effecting a personal care treatment to said body surface, and a determination unit including at least one sensor for determining stroke length to differentiate between short and long strokes, characterized in that said determination unit is configured to determine velocity of the working head and/or the handle, to determine beginning and end points of strokes when the determined velocity gets zero and/or changes signs, and to determine stroke length from the distance between pairs of beginning and end points next to each other.

2. Personal care device according to claim 1, wherein said determination unit includes an acceleration sensor accommodated in the handle to determine acceleration thereof, wherein the determination unit further includes an evaluation unit for evaluating the acceleration signal of the acceleration sensor and determining velocity from the acceleration signal and/or wherein the working head is provided to swivel relative to the handle.

3. Personal care device according to claim 1, wherein said evaluation unit is configured to integrate the acceleration signal overtime to determine velocity.

4. Personal care device according to claim 1, wherein the determination unit comprises in addition to the acceleration sensor also a rotation sensor for detecting rotational movements of the handle.

5. Personal care device according to claim 1, wherein the rotation sensor is configured to provide a correction signal to the determined velocity.

6. Personal care device according to claim 1, wherein the evaluation unit includes a low pass filter for performing a mathematical integration for determining the velocity based on an acceleration signal, and/or said low pass filter having a cut-off frequency set at a value below expected frequencies of short and long strokes to perform the mathematical integration for frequencies above the cut-off frequency.

7. Personal care device according to claim 1, wherein the cut-off frequency of said low pass filter is within a range of about 0.20 Hz to about 0.40 Hz or about 0.25 Hz to about 0.35 Hz or about 0.25 Hz to about 0.30 Hz.

8. Personal care device according to claim 1, wherein the determination unit includes a filter for removing influences resulting from vibrations of the personal care device to onto the acceleration signal of the acceleration sensor, wherein in particular a low pass filter of second order having a cut-off frequency set between frequencies of expected vibrations of the personal care device and a highest expected frequency of the short and long strokes, said cut-off frequency more particularly ranging from about 10 Hz to about 100Hz, or about 20 Hz to about 40 Hz or about 25 Hz to about 35 Hz.

9. Personal care device according to claim 1, wherein the determination unit includes a filter for removing influences of gravity onto the acceleration signal of the acceleration sensor.

10. Personal care device according to claim 1, wherein said filter for removing influences of gravity is a high pass filter having a cut-off frequency ranging from about 0.8 Hz to about 2.0 Hz or about 1.0 Hz to about 1.5 Hz.

11. Personal care device according to claim 1, wherein the determination unit includes a comparator for comparing the determined stroke lengths to a reference value forming a boundary between long strokes and short strokes, and furthermore a dynamic reference value determinator for dynamically determining the reference value from the stroke lengths of a number of preceding strokes.

12. Personal care device according to claim 1, wherein said dynamic reference value determinator is configured to determine a sliding average of the stroke lengths of two or more preceding strokes or a sliding average as specified over a predetermined time period.

13. Personal care device according to claim 1, wherein said dynamic reference value determinator includes a scaling factor applicator for applying a scaling factor to the stroke length of the preceding strokes used for determining the reference value, said scaling factor applicator being configured to give more weight to stroke lengths of more recent strokes than to stroke lengths of compared to that less recent strokes.

14. Personal care device according to claim 1, wherein the determination unit is configured to disregard stroke lengths exceeding a predetermined maximum value.

15. Personal care device according to claim 1, wherein the acceleration sensor of the determination unit is configured to measure accelerations along at least one axis extending substantially parallel to a skin contact surface of the working head and substantially parallel to a longitudinal sectional plane parallel to the longitudinal axis of the handle and substantially perpendicular to the skin contact surface of the working head, or to measure accelerations along two axis perpendicular to each other and parallel to the skin contact surface of the working head.

16. Personal care device according to claim 1, wherein the acceleration sensor is configured to measure accelerations along at least one of a first axis extending in the longitudinal handle direction, a second axis extending perpendicular to the first axis and through a front and back side of the handle and/or a third axis perpendicular to the first and second axis.

17. Personal care device according to claim 1, wherein the determination unit includes a rotation sensor for measuring rotatory speed and/or rotatory acceleration, and a correction unit for correcting the acceleration signal of the acceleration sensor on the basis of the measured rotatory speed and/or rotatory acceleration and the distance between the acceleration sensor and the skin contact surface of the working head.

18. Personal care device according to claim 1, wherein the determination unit includes a counter for counting the number of short strokes and/or long strokes, wherein said counter is configured to be reset to zero whenever a stroke exceeds a maximum accepted length and/or an average value of determined velocity is lower than a predefined threshold.

19. Personal care device according to claim 1, wherein the determination unit is configured to issue a stroke pattern change signal indicative of a change from a long stroke pattern to a short stroke pattern and/or from a short stroke pattern to a long stroke pattern when a predefined number of short strokes and/or a predefined number of long strokes has been counted, said predefined number being larger than one and lower than six.

20. Personal care device according to claim 1, further comprising an adjustment device including at least one adjustment actuator for adjustment at least one treatment characteristic in response to a signal from the determination unit indicative of a change of the stroke length pattern or indicative of the determined stroke length pattern.

21. Personal care device according to claim 1, wherein said adjustment device includes at least one adjustment actuator for adjusting tilting stiffness and/or swiveling stiffness and/or diving stiffness of the working head and/or swiveling stiffness and/or tilting stiffness and/or diving stiffness of a working tool relative to a working head basis in response to said signal from the determination unit indicative of a change of the stroke length pattern.

22. Personal care device according to claim 1, wherein the determination unit is provided for determining the stroke length during the body treatment operation, in particular in real time

23. Personal care device according to claim 1, wherein the personal care device comprises two separate parts, the first part is provided for effecting the body treatment and the second part comprising at least partially the determination unit.

24. Personal care device according to claim 1, wherein the second part being effected in a smart device as e.g. a smartphone or a wearable device.

25. Personal care device, optionally in accordance with claim 1, in particular hair removal device such as an electric shaver, comprising an elongated handle for manually moving the personal care device in short and/or long strokes along a body surface, a working head attached to said handle for effecting a personal care treatment to said body surface, and a determination unit including at least one sensor for determining stroke length to differentiate between short and long strokes, characterized by a second sensor configured to measure correction signals for correcting the stroke length determination signal.
